(19) United States
(12) Patent Application Publication
(10) Pub. No.: US 2023/0114352 A1
(43) Pub. Date: Apr. 13, 2023

(54) MULTISTAGE CENTRIFUGAL PUMP WITH TWO PARALLEL FLOWS OF PUMPED MEDIUM

(71) Applicant: OOO Neftekamskij mashinostroitelnyj zavod, Neftekamsk (RU)

(72) Inventors: Vladimir Ivanovich Kushnarev, Moscow (RU); Ivan Vladimirovich Kushnarev, Moscow (RU); Yurij Sergeevich Oboznyj, Sumy (UA)

(21) Appl. No.: 17/629,364

(22) PCT Filed: Jan. 31, 2020
(86) PCT No.: PCT/RU2020/000050

§ 371 Date: Jan. 21, 2022

(30) Foreign Application Priority Data
Jul. 23, 2019 (RU) 2019123176

(51) Int. Cl. F04D 1/06; F04D 29/42; F04D 29/62

(52) U.S. Cl. CPC F04D 1/06; F04D 29/426; F04D 29/628

(57) ABSTRACT

The invention relates to the field of pump design. A multistage centrifugal pump with two parallel flows of pumped medium comprises a housing consisting of two separate parts, each of which contains impellers and guide apparatus, and a central pressure cover mounted between said parts of the housing. A delivery pipe is vertical and centrally oriented. The pump additionally includes an end transfer cover for transferring fluid from the first part of the housing to the second part via transfer channels provided integrally with the pressure cover and the transfer cover. The impellers are arranged in the first and second parts of the housing such as to be opposed to one another in relation to the central pressure cover. The first part of the housing comprises a horizontal suction pipe and a vertical discharge pipe, which are disposed on the drive side of the pump and are configured in the form of a single cast part. The discharge pipe is connected by a transfer pipe to an annular chamber in the central pressure cover. The invention is directed toward simplifying the installation, assembly and repair of the pump in an operating environment, reducing the length of the pump piping, and allowing for disassembly and repair of the wet end of the pump without disconnecting the suction and discharge pipes.

The present solution relates to the field of pump engineering, specifically to the design of a centrifugal radially split pump, which is used to maintain the intrastratal pressure of oil fields by injecting fluid under high pressure. The pumps of this type can also be used in thermal and nuclear power, mining industry.

Known is a pump with one-sided arrangement of impellers, see patent RU 2529979 dated Oct. 10, 2014. In this pump, the pumped liquid first enters the suction pipe, then moves into the impeller of the first stage and subsequent stages, gradually acquiring pressure energy and is ejected into the discharge pipe of the discharge cover at a predetermined pressure and flow rate. Further, the pump design provides for a suction pipe disposed on the drive end of the pump, and a discharge pipe disposed on the nondrive end of the pump. The disadvantage of the given design is the presence of a quick-wear unit for hydraulic unloading of axial force, i.e. a hydraulic balancing apparatus.

The closest technical solution selected as a prototype is a pump with two-sided arrangement of impellers, see patent RU 2600662 dated Oct. 27, 2016. In this pump, the pumped liquid first enters the suction pipe, then moves into the impeller of the first stage, and subsequent stages of the first package of sections, then enters the annular chamber of the central cover, therefrom it is transferred through transfer pipes into the annular chamber of the transfer cover, then into the impeller of the first stage of the second package, and subsequent stages of the second package of sections, and is ejected into the discharge pipe of the central cover at a predetermined pressure and flow rate. Further, the pump design provides for a suction pipe disposed on the drive end of the pump, and a discharge pipe disposed vertically in relation to the center of the pump.

The disadvantage of this design is that the discharge pipe is disposed in the center of the pump and that there are provided two additional supports of the pump casing, which fact is not typical for the designs of pumps of this family and requires additional installation and construction works for mounting thereof, although it is advantageous over patent RU 2529979 in that the quick-wear hydraulic balancing unit is absent.

The main general object of the present technical solution is to provide a centrifugal radially split pump with two parallel flows of pumped medium, which will be easy and convenient to mount at the installation site, connect to a common pipeline system used to maintain the intrastratal pressure of oil fields, mining, nuclear and thermal power and introduce into operation; further, the pipeline system to which the pump is connected becomes significantly more compact due to the fact that the discharge and suction pipes are disposed in the area of the inlet cover of the pump.

The technical result consists in simplification of installation (saving time), mounting and repair of the pump under operating conditions, reduction in the length of the pump piping, the possibility of dismantling and repair, as well as mounting and repair of the flow portion of the pump without disconnecting the suction and discharge pipelines.

The technical result is achieved by the fact that the centrifugal radially split pump with two parallel flows of pumped medium is configured as a pump casing comprising two individual portions, each accommodating impellers and guide vanes and a central discharge cover installed therebetween, with a vertical centrally oriented discharge pipe. Further provided is a transfer end cover for transferring liquid from the first portion of the casing to the second portion of the casing via transfer channels provided in the discharge and transfer covers and integral therewith, and the impellers mounted on the shaft and accommodated in the first and second portions of the casing are disposed opposite each other relative to the central discharge cover. Further, the first portion of the pump casing comprises a horizontal suction pipe and a vertical discharge pipe disposed on the drive end of the pump and configured as a single cast part, wherein the vertical discharge pipe is connected by a transfer pipe to the annular chamber of the central discharge cover.

Further, the transfer pipe connecting the discharge pipe with the central discharge cover extends horizontally along the entire length of the first portion of the pump casing.

The invention will be explained by a figure

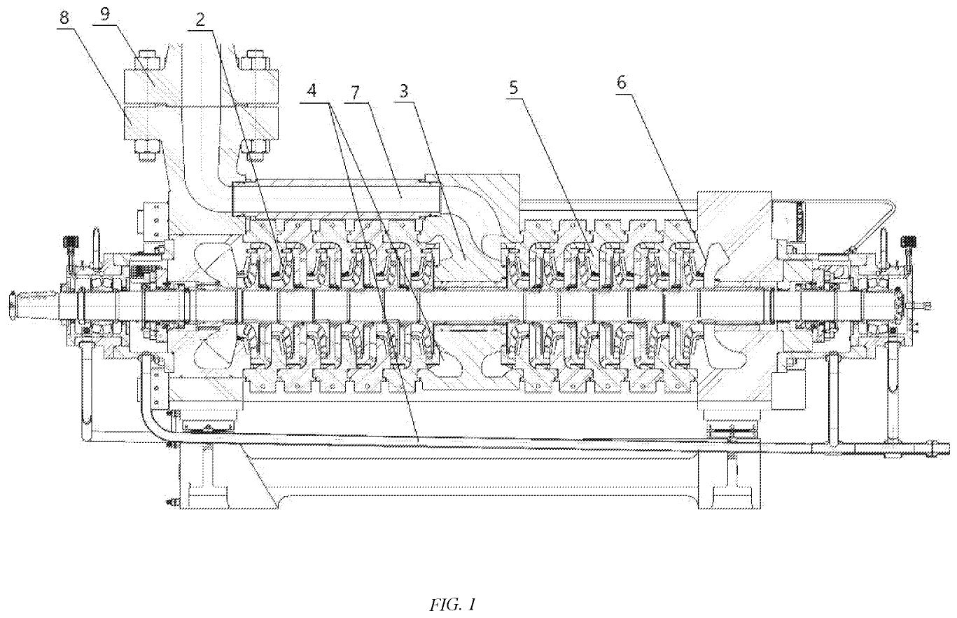

FIG. 1 is a centrifugal sectional pump with two parallel flows of pumped medium.

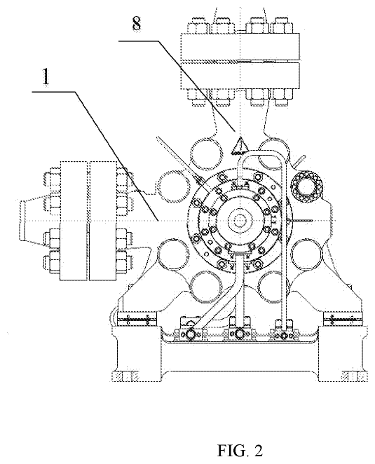

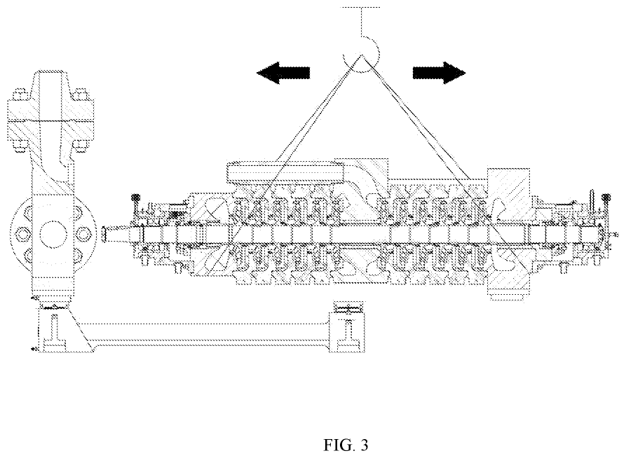

FIG. 2 a dismantling and mounting diagram of the flow portion of the present pump.

The centrifugal radially split pump with two parallel flows of pumped medium consists of:
1—suction pipe,
2—first-stage impellers,
3—central discharge cover,
4—transfer pipes,
5—second-stage impellers,
6—transfer cover,
7—transfer pipe of the annular chamber of the central cover;
8—discharge pipe,
9—discharge flange of the suction cover.

The present centrifugal pump operates as follows: the pumped liquid first enters the suction pipe 1, then moves into the first stage impeller, and then into subsequent impellers of the second stage of the first package of sections, then enters the annular chamber of the central discharge cover 3, therefrom, via the transfer pipes 4, it is transferred to the annular chamber of the transfer cover 6, then to the impeller of the first stage, and subsequent stages 5 of the second package of sections, then transferred through the transfer pipe 7 of the annular chamber of the central cover 3 to the discharge pipe 8 installed at the beginning of the first stage and then ejected into the discharge flange of the suction cover 9 at a predetermined pressure and flow rate. Further, the pump design comprises a suction pipe 1 and a discharge pipe 8 disposed on the drive end of the pump and configured as a single cast part with different annular chambers, a suction chamber and discharge chamber.

The present invention is devoid of the disadvantage of the first U.S. Pat. No. 2,529,979, i.e. of a hydraulic balancing device. Thanks to the original disposition of the pipes, it is devoid of the disadvantage of U.S. Pat. No. 2,600,662, i.e. a non-typical (central) disposition of the discharge pipe and additional support legs (four legs instead of six legs); further, the advantage of a pump with an opposite arrangement of impellers in order to compensate for axial forces is maintained, which fact improves the reliability of pump design and makes the pump serviceable in field conditions, thus significantly reducing operating costs.

The MAIN advantage of the present invention is the possibility of dismantling and repair, as well as the possibility of mounting of the flow portion of the pump without disconnecting the suction and discharge pipelines, as shown in FIG. 2.

1. A centrifugal radially split pump with two parallel flows of pumped medium, configured as a pump casing comprising two individual portions, each accommodating impellers and guide vanes and a central discharge cover installed therebetween, with a vertical centrally oriented discharge pipe, wherein further provided is a transfer end cover for transferring liquid from the first portion of the casing to the second portion of the casing via transfer channels provided in the discharge and transfer covers and integral therewith, and the impellers mounted on the shaft and accommodated in the first and second portions of the casing are disposed opposite each other relative to the central discharge cover, characterized in that the first portion of the pump casing comprises a horizontal suction pipe and a vertical discharge pipe disposed on the drive end of the pump and configured as a single cast part, wherein the vertical discharge pipe is connected by a transfer pipe to the annular chamber of the central discharge cover.
